(19) United States
(12) Patent Application Publication
(10) Pub. No.: US 2009/0051673 A1
(43) Pub. Date: Feb. 26, 2009

(54) Wireless digital data storage device mounted in a pen shaped housing

(76) Inventors: Hong-Chi Yu, K.E.P.Z. Kaohsiung (TW); Ping-Hua Chu, K.E.P.Z. Kaohsiung (TW)

Correspondence Address: Hershkovitz & Associates, LLC, 2845 Duke Street, Alexandria, VA, 22314, US

(21) Appl. No.: 11/892,352

(22) Filed: Aug. 22, 2007

(51) Int. Cl. G06F 3/033

(52) U.S. Cl. 345/179

(57) ABSTRACT

A wireless digital data storage device mounted in a pen shaped housing has a barrel, a reservoir tube assembly and a memory device. The memory device is held in the barrel and the memory device having a controller, a memory unit, a wireless communicating unit and a display. The controller is electronically connected to the memory unit, the wireless communicating unit and the display. The wireless communicating unit is used to link to computer device to transmit data stored in the memory or receive data from the computer device. Therefore, the wireless digital data storage device can be used to access, store and exchange digital data in wireless way and to perform writing function.

### BACKGROUND OF THE INVENTION

1. Field of the Invention

The present invention relates to a data storage device, and more specifically to a wireless digital data device is wireless linking to electronic devices and is mounted in a pen shaped housing.

2. Description of Related Art

Pens have been very convenient tools for writing for a very long time and are easily carried. Because pens are small enough to easily carry, other functions such as laser pointers have been incorporated into pens and pen-shaped housings. Recently, portable products have been developed to process or store digital data for electronic devices such as notebook computers, PDAs, digital videos, digital cameras, etc. Therefore, a digital data processing or storage device has been adapted to be mounted in a pen shaped housing with a pen or other device to improve the utility of both the device and the portable digital data storage device mounted in the pen shaped housing.

The present invention provides a wireless digital data storage capability mounted in a relatively small pen shaped housing.

### SUMMARY OF THE INVENTION

An objective of the present invention is to provide a wireless digital data device in a pen shaped housing to interface with electronic devices. That is, the pen shaped housing can be wireless linked to a computer or other electronic device to access store and exchange digital data to and from electronic devices such as a computer.

Other objectives, advantages and novel features of the invention will become more apparent from the following detailed description when taken in conjunction with the accompanying drawings.

### BRIEF DESCRIPTION OF THE DRAWINGS

FIG. 1 is a front plan view of a wireless digital data storage device in a pen shaped housing in accordance with the present invention;

FIG. 2 is a side plan view in partial section of the device in FIG. 1;

FIG. 3 is another side plan view in partial section of the device in FIG. 1; and

FIG. 4 is a functional diagram of a circuit of the device in FIG. 1.

### DETAILED DESCRIPTION OF THE PREFERRED EMBODIMENT

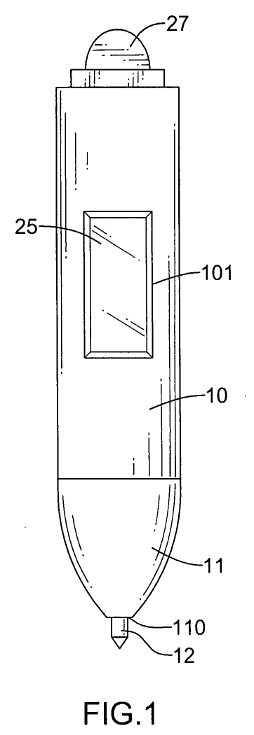

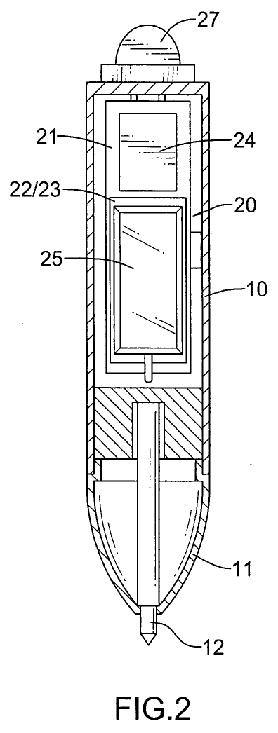

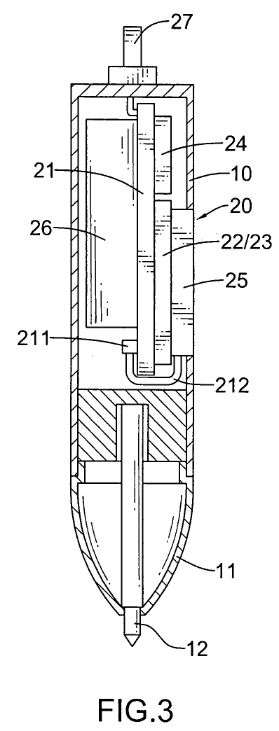

With reference to FIGS. 1 to 3, a wireless digital data storage device in a pen shaped housing in accordance with the present invention has a barrel, a reservoir tube assembly and a wireless memory device (20).

The barrel includes an upper casing (10) and a bottom casing (11) detachably connected to the upper casing (10). A side opening (101) is defined outside the upper casing (10). The upper casing (10) has a bottom opening. An inner thread is formed in the upper casing (10) and close to the bottom opening and the bottom casing (11) has a top ring with an outer thread screwed to the upper casing (10). The bottom casing (11) has a point opening.

The reservoir tube assembly includes a retaining bolt (14) and a reservoir tube (12). The retaining bolt (14) has a bottom end (not numbered). The retaining bolt (14) is held inside the upper casing (10) and close to the bottom opening. An end of the reservoir tube (12) is pressed against to the retaining bolt (14). The other end of the reservoir tube (12) protrudes through the point opening of the bottom casing (11).

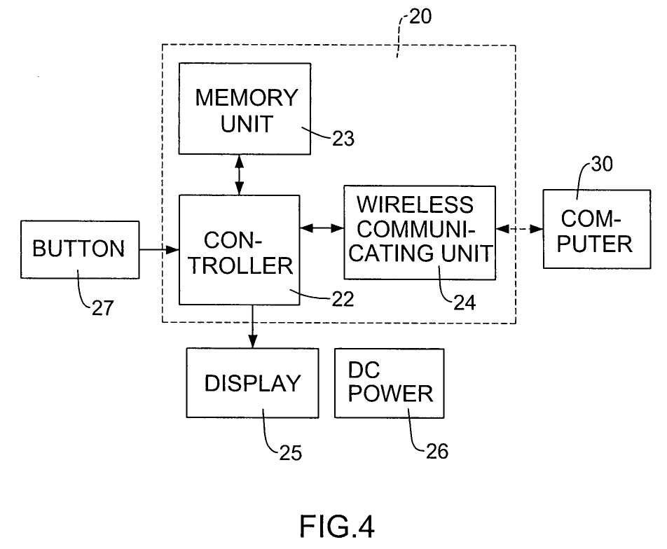

With further reference to FIG. 4, the memory device (20) is held inside the upper casing (10) and has a printed circuit board (herein after PCB) (21), a controller (22), a memory unit (23), a wireless communicating unit (24), a display (25), a button (27) and a DC power (26).

The PCB (21) has a connector (21) and a flexible printed circuit board (hereinafter FPCB) (212). An end of the FPCB (212) plugs into the connector (21).

The controller (22) is mounted on the PCB (21) and has at lest a data transmitting and receiving or a locking functions.

The memory unit (23) can be mounted on the PCB (21) or integrated to the controller (22). The memory unit (23) is electronically connected to the controller (22) to store data from the controller (22). The memory unit (23) is a flash memory.

The wireless communicating unit (24) is mounted on the PCB (21) and electronically connected to the controller (22) so the controller (22) controls the wireless communicating unit (24) to transmit or receive wireless signal. The wireless communicating unit (24) is used to link to a computer (30) to transmit data stored in memory unit (23) or receive data from the computer (30).

The display (25) is mounted inside the upper casing (10), corresponds to the side opening (101) and electronically connected to the controller (22). In this embodiment, the display (25) is connected to the end of the FPCB (212) to electronically connect to the controller (22).

The button (27) is mounted on a top of the upper casing (10) and electronically connected to the controller (22). The user uses the button and the display (25) to selects a specific function of the controller (22).

The DC power (26) is mounted inside of the upper casing (10) and electronically connected to the controller (22), the memory unit (23), the wireless communicating unit (24) and the display (25).

Since the display (25) is mounted inside of the upper casing (10), the FPCB (212) is first separated from the connector (211) on the PCB (21) and then the PCB (21) can be pulled from the upper casing (10), if the user would like to replace the DC power inside the upper casing (10). Further, the controller (22), the memory unit (23) and the wireless communicating unit (24) can be integrated to an Integrated circuit.

When the user simultaneously uses the writing function and wireless receiving and transmitting data function of the wireless digital data storage device.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A wireless digital data storage device mounted in a pen shaped housing, comprising:
a barrel having an upper casing and a bottom casing detachably connected to the upper casing, wherein the upper casing has a side opening and a point opening formed an bottom of the bottom casing;
a reservoir tube assembly held in the bottom casing and having a retaining bolt protruding through the point opening; and
a memory device held in the upper casing, wherein the memory device has
a printed circuit board;
a controller mounted on the printed circuit board and having at lest a data transmitting and receiving function;
a memory unit mounted on the printed circuit board and electronically connected to the controller to store data from the controller;
a wireless communicating unit mounted on the printed circuit board and electronically connected to the controller so the controller controls the wireless communicating unit to transmit or receive wireless signal;
a display mounted inside the upper casing, corresponds to the side opening and electronically connected to the controller;
a button mounted on the upper casing and electronically connected to the controller; and
a DC power held inside of the upper casing and electronically connected to the controller, the memory unit, the wireless communicating unit and the display.

2. The wireless digital data storage device mounted in a pen shaped housing as claimed in claim 1, further comprising:
a connector mounted on the printed circuit board; and
a flexible printed circuit board having two ends, wherein one end plugs into the connector, and the other end is connected to the display.

3. The wireless digital data storage device mounted in a pen shaped housing as claimed in claim 1, wherein the controller and the memory unit are integrated to an integrated circuit.

4. The wireless digital data storage device mounted in a pen shaped housing as claimed in claim 2, wherein the controller and the memory unit are integrated to an integrated circuit.

5. The wireless digital data storage device mounted in a pen shaped housing as claimed in claim 1, wherein the controller, the memory unit and the wireless communicating unit circuit are integrated to an integrated circuit.

6. The wireless digital data storage device mounted in a pen shaped housing as claimed in claim 2, wherein the controller, the memory unit and the wireless communicating unit circuit are integrated to an integrated circuit.

7. The wireless digital data storage device mounted in a pen shaped housing as claimed in claim 1, wherein an inner thread is formed in the upper casing and close to the bottom opening and the bottom casing has a top ring with an outer thread screwed to the upper casing.

8. The wireless digital data storage device mounted in a pen shaped housing as claimed in claim 1, wherein the reservoir tube assembly further comprises a retaining bolt held where the reservoir tube is pressed.
